(19) United States
(12) Patent Application Publication
(10) Pub. No.: US 2026/0309108 A1
(43) Pub. Date: Oct. 8, 2026

(54) FAILURE DETECTION DEVICE FOR EXHAUST GAS RECIRCULATION DEVICE

(71) Applicant: MITSUBISHI JIDOSHA KOGYO KABUSHIKI KAISHA, Tokyo (JP)

(72) Inventors: Yoshikazu MATSUDA, Tokyo (JP); Kazumichi TAKAHASHI, Tokyo (JP); Kyosuke UEMATSU, Tokyo (JP); Hideo MATSUNAGA, Tokyo (JP); Hitoshi TODA, Tokyo (JP); Junpei AWATA, Tokyo (JP)

(73) Assignee: MITSUBISHI JIDOSHA KOGYO KABUSHIKI KAISHA, Tokyo (JP)

(21) Appl. No.: 19/482,178

(22) PCT Filed: Jul. 9, 2024
(86) PCT No.: PCT/JP2024/024794

§ 371 Date: Nov. 6, 2025

(30) Foreign Application Priority Data
Jul. 24, 2023 (JP) 2023-119672

(51) Int. Cl. F02M 26/49

(52) U.S. Cl. CPC F02M 26/49

(57) ABSTRACT

A failure detection device for an exhaust gas recirculation device includes: a failure type estimation unit for estimating a type of failure that has occurred in the exhaust gas recirculation device; and a determination unit for determining presence or absence of a failure from an intake air pressure change when opening degree of an exhaust gas recirculation valve is changed during a fuel cut operation. The determination unit is configured to determine the presence or absence of a failure by changing the opening degree of the exhaust gas recirculation valve in accordance with the type of failure estimated by the failure type estimation unit during failure diagnosis.

### TECHNICAL FIELD

The present invention relates to a failure detection device for an exhaust gas recirculation device.

### BACKGROUND ART

In general, an exhaust gas recirculation device, which introduces a portion of the exhaust gas, as recirculated exhaust gas, into intake air, is disposed between an exhaust passage and an intake passage of an engine. The exhaust gas recirculation device includes an exhaust gas recirculation passage through which the exhaust passage and the intake passage communicate with each other, an exhaust gas recirculation valve disposed in the exhaust gas recirculation passage, and other components. An appropriate required amount of recirculated exhaust gas is introduced into the intake air based on the pressure conditions in the intake passage, which result from the opening and closing operations of the exhaust gas recirculation valve, the throttle valve, and other related components. Since the introduction of recirculated exhaust gas into the intake air lowers the combustion temperature in the combustion chamber, this temperature reduction contributes to a decrease in nitrogen oxides, improved fuel economy, and even a reduction in engine knocking.

However, an abnormality (i.e., a failure) may occur in the exhaust gas recirculation device due to aging or other factors. Examples of possible causes include sticking of the exhaust gas recirculation valve, jamming caused by foreign matter in the exhaust gas recirculation valve, and clogging caused by foreign matter in the exhaust gas recirculation passage.

If the content of the failure is a state in which the exhaust gas recirculation valve fails to be closed from a certain opening degree due to open sticking in which the exhaust gas recirculation valve is stuck in an open state, or due to jamming caused by foreign matter in the exhaust gas recirculation valve, a situation is assumed in which an excessively large amount of recirculated exhaust gas is introduced into the intake air, resulting in unstable combustion. In contrast, if the content of the failure is a state in which the flow rate of recirculated exhaust gas becomes less than a normal value (i.e., a desired value) due to closed sticking in which the exhaust gas recirculation valve is stuck in a closed state, or due to clogging caused by foreign matter in the exhaust gas recirculation passage, a situation is assumed in which the amount of the recirculated exhaust gas introduced into the intake air becomes excessively small, and as a result, the combustion temperature may increase under certain operating conditions.

In order to detect such failures, a failure detection device as disclosed in the below-identified Patent Document 1 has been proposed. In this failure detection device, as part of the failure diagnosis operation, when the difference between an intake air pressure (P1), measured after a predetermined time has elapsed with the exhaust gas recirculation valve fully closed, and an intake air pressure (P2), measured after a predetermined time has elapsed with the exhaust gas recirculation valve subsequently open, is equal to or greater than a predetermined value, it is determined that the exhaust gas recirculation valve has failed.

### PRIOR ART DOCUMENT(S)

### Patent Document(s)

Patent Document 1: Japanese Unexamined Patent Application Publication No. 2022-128831

### SUMMARY OF THE INVENTION

### Problems to be Solved by the Invention

In the conventional failure detection device, the opening degree of the exhaust gas recirculation valve during failure detection is always set to a fixed value. As a result, there is a possibility that the accuracy of failure determination may vary depending on the type of failure. For example, in the case of a failure in which the flow rate of recirculated exhaust gas is larger than a normal flow rate, if the opening degree set during failure detection is higher (i.e., higher than the opening degree at which jamming occurs), the intake air pressure difference (P2−P1) may become equal to or greater than the predetermined value regardless of whether a failure has occurred, and as a result, the failure cannot be detected.

In view of the above, it is an object of the present invention to further improve the failure detection accuracy of the exhaust gas recirculation device and enable substantive failure determination in accordance with the content of the failure.

### Means for Solving the Problems

In order to achieve the above object, the present invention provides a failure detection device for an exhaust gas recirculation device, the exhaust gas recirculation device comprising: an exhaust gas recirculation passage through which an exhaust passage and an intake passage of an engine communicate with each other, and an exhaust gas recirculation valve disposed in the exhaust gas recirculation passage, wherein the failure detection device comprises: a failure type estimation unit for estimating a type of failure that has occurred in the exhaust gas recirculation device; and a determination unit for determining presence or absence of a failure from an intake air pressure change when opening degree of the exhaust gas recirculation valve is changed during a fuel cut operation, and wherein the determination unit is configured to determine the presence or absence of a failure by changing the opening degree of the exhaust gas recirculation valve in accordance with the type of failure estimated by the failure type estimation unit during diagnosis of the present or absence of failure (arrangement 1).

With this arrangement 1, changing the opening degree of the exhaust gas recirculation valve during failure determination in accordance with the failure type makes it possible to increase the failure determination accuracy.

In an aspect including the arrangement 1, an arrangement 2 may be used in which the failure type estimation unit is configured to estimate a first failure in which a flow rate of recirculated exhaust gas is larger than a normal flow rate, when a difference between an intake air amount on an upstream side of a connection portion of the intake passage connected to the exhaust gas recirculation passage and an intake air amount on a downstream side of the connection portion of the intake passage, with the exhaust gas recirculation valve closed, is equal to or greater than a first threshold, and wherein the determination unit is configured to set, when the first failure is estimated, the opening degree of the exhaust gas recirculation valve so as to be smaller than the opening degree of the exhaust gas recirculation valve when the first failure is not estimated.

With this arrangement 2, when the first failure (i.e., a failure in which the flow rate of recirculated exhaust gas is larger than the normal flow rate due to jamming caused by foreign matter in the exhaust gas recirculation valve or other factors) is estimated, the opening degree of the exhaust gas recirculation valve during failure diagnosis is rendered lower than the opening degree of the exhaust gas recirculation valve when a different failure (i.e., such as a failure in which the flow rate of recirculated exhaust gas is smaller than the normal flow rate) is estimated. This makes it possible to increase the failure determination accuracy in the failure in which the flow rate of recirculated exhaust gas is larger than the normal flow rate.

In an aspect including the arrangement 2, an arrangement 3 may be used in which the failure type estimation unit is configured to estimate the first failure when (i) the difference between the intake air amounts on the upstream side and the downstream side of the connection portion of the intake passage is equal to or greater than the first threshold, and (ii) a condition in which a rotational fluctuation of the engine is equal to or greater than a second threshold is detected a predetermined number of times. With this arrangement 3, the first failure can be estimated more accurately.

In an aspect including the arrangement 2, an arrangement 4 may be used in which the failure type estimation unit is configured to estimate a second failure in which the flow rate of recirculated exhaust gas is smaller than a normal flow rate, when the difference between the intake air amounts on the upstream side and the downstream side of the connection portion of the intake passage, with the exhaust gas recirculation valve open, is less than a third threshold, and wherein the determination unit is configured to set, when the second failure is estimated, the opening degree of the exhaust gas recirculation valve during failure determination so as to be greater than the opening degree of the exhaust gas recirculation valve when a failure other than the second failure is estimated. This arrangement 4 may be used even in an aspect of the arrangement 1 not including the arrangement 2.

With this arrangement 4, when the second failure (i.e., a failure in which the flow rate of recirculated exhaust gas is smaller than the normal flow rate due to clogging caused by foreign matter in the exhaust gas recirculation passage or other factors) is estimated, the opening degree of the exhaust gas recirculation valve during failure diagnosis is higher than the opening degree of the exhaust gas recirculation valve when a different failure (i.e., such as the failure in which the flow rate of recirculated exhaust gas is larger than the normal flow rate) is estimated. Accordingly, in the case of a failure in which the flow rate of recirculated exhaust gas is smaller than the normal flow rate, failure determination is less likely to be performed than in other types of failure, thereby enabling diagnosis to be performed in accordance with the degree of urgency.

In an aspect including the arrangement 4, an arrangement 5 may be used in which the failure type estimation unit is configured to estimate the second failure when (i) the difference between the intake air amounts on the upstream side and the downstream side of the connection portion of the intake passage is less than the third threshold, and (ii) a condition in which the rotational fluctuation of the engine is equal to or greater than a fourth threshold is detected a predetermined number of times. With this arrangement 5, the second failure can be estimated more accurately.

In an aspect including the arrangement 4, an arrangement 6 may be used in which, when the failure type estimation unit estimates both the first failure and the second failure, the determination unit is configured to decrease the opening degree of the exhaust gas recirculation valve set during failure determination. This arrangement 6 is directed to prioritizing the determination of the first failure, in the interest of safety, when both the first failure and the second failure are of concern. That is, as a failure type estimated by the failure type estimation unit, the first failure is prioritized over the second failure.

In an aspect including the arrangement 4, an arrangement 7 may be used in which the determination unit is configured to notify an occupant of occurrence of a failure only when it is determined that the first failure has occurred. This arrangement 7 is directed to reducing unnecessary notifications to the occupant by making it relatively difficult to determine a failure compared to another failure, because the amounts of harmful components in the exhaust gas do not increase in the failure in which the flow rate of recirculated exhaust gas decreases.

### Effects of the Invention

According to the present invention, the accuracy of failure determination for the exhaust gas recirculation device can be further improved, thereby enabling substantive failure determination in accordance with the content of the failure.

### BRIEF DESCRIPTION OF THE DRAWINGS

FIG. 1 is a structural schematic diagram of an engine including an exhaust gas recirculation device and a failure detection device therefor, showing an embodiment of the present invention.

FIG. 2A is a graph showing an example of control according to the present invention.

FIG. 2B is a graph showing an example of control according to the present invention.

FIG. 2C is a graph showing an example of control according to the present invention.

FIG. 2D is a graph showing an example of control according to the present invention.

FIG. 3A is a graph illustrating control according to the present invention.

FIG. 3B is a graph illustrating control according to the present invention.

FIG. 3C is a graph illustrating control according to the present invention.

FIG. 4 is a flowchart illustrating the control process according to the present invention.

### BEST MODE FOR CARRYING OUT THE INVENTION

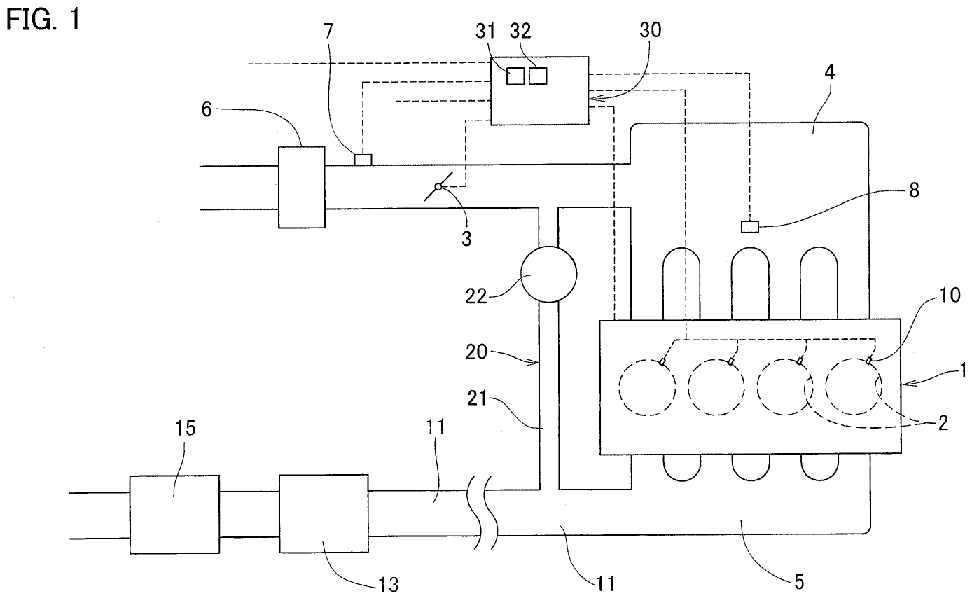

An embodiment of the present invention will be described below with reference to the accompanying drawings. FIG. 1 is a schematic diagram showing the structure of an engine 1 including an exhaust gas recirculation device and a failure detection device therefor, according to the present invention.

The engine 1 is a four-cylinder engine for an automobile. As shown in FIG. 1, the engine 1 includes four cylinders (combustion chambers) 2 arranged in parallel and each accommodating a piston; an intake passage 4 connected to intake ports for supplying air into the respective cylinders 2; an exhaust passage 5 connected to exhaust ports for discharging exhaust gas from the respective cylinders 2; and injection devices 10 for supplying fuel to the respective cylinders 2. In FIG. 1, only the components and means directly related to the present invention are shown, and other components and the like are not shown. In addition, the number of cylinders 2 is four in the shown example, but is not limited thereto, and the arrangement of cylinders is not limited to an in-line arrangement. Further, while the injection devices 10 are to directly inject fuel into the respective cylinders 2, the injection devices 10 may be configured to inject fuel into the intake ports.

A throttle valve 3 for adjusting the flow passage area is disposed in an upstream portion of the intake passage 4, thereby enabling regulation of the intake air amount. In addition, the exhaust passage 5 is provided with various sensors (not shown), such as an air-fuel ratio sensor for detecting the air-fuel ratio in the exhaust passage 5. Further, an exhaust gas cleaner 13 including a catalyst for removing harmful substances from the exhaust gas is disposed in a downstream portion of the exhaust passage 5, and a muffler 15 is disposed in a portion of the exhaust passage 5 on the downstream side of the exhaust gas cleaner 13.

Disposed between the intake passage 4 and the exhaust passage 5 is an exhaust gas recirculation device 20 including an exhaust gas recirculation passage 21 through which the intake passage 4 and the exhaust passage 5 communicate with each other, and an exhaust gas recirculation valve 22 for opening and closing the exhaust gas recirculation passage 21. The exhaust gas recirculation passage 21 is connected to a portion of the intake passage 4 on the downstream side of the throttle valve 3. A portion of the exhaust gas is introduced as recirculated exhaust gas into the intake air in accordance with the pressure conditions in the intake passage 4 caused, e.g., by opening and closing the exhaust gas recirculation valve 22 and the throttle valve 3.

Devices necessary for the operation of the engine, including the throttle valve 3, the injection devices 10, and the exhaust gas recirculation valve 22, are individually controlled by an electronic control unit 30 of the vehicle in which the engine 1 is installed. In addition, information from various sensors is transmitted to the electronic control unit 30.

The electronic control unit 30 controls the throttle valve 3 to regulate the intake air amount of the intake passage 4 and the amount of fuel injected into each cylinder 2 from the corresponding injection device 10 by feedback control, thereby controlling the air-fuel ratio in the cylinder 2. Exhaust gas from each cylinder 2 is discharged to the exhaust passage 5, cleaned by the exhaust gas cleaner 13, and then discharged through the muffler 15. In addition, the electronic control unit 30 controls the opening and closing of the exhaust gas recirculation valve 22 and the pressure conditions in the intake passage 4 in accordance with the operational conditions of the engine, thereby regulating the amount of the recirculated exhaust gas introduced into the intake air. The amount of the recirculated exhaust gas introduced into the intake air may be regulated by feedback control such that the actual exhaust gas recirculation ratio approaches the target exhaust gas recirculation ratio.

In addition, the electronic control unit 30 includes a function (device) for detecting a failure of the exhaust gas recirculation device 20. Specifically, the electronic control unit 30 includes a failure type estimation unit 31 for estimating the type of failure that has occurred in the exhaust gas recirculation device 20; and a determination unit 32 for determining the presence or absence of a failure from changes in the intake air amount when the opening degree of the exhaust gas recirculation valve 22 is changed during a fuel cut operation. Examples of information on the “changes in the intake air amount” include information on changes in the intake air pressure in the intake passage 4 and information on changes in volumetric efficiency. As shown in FIG. 1, the intake air amount in the intake passage 4 can be acquired using information from, for example, an intake air amount sensor 7 disposed in a portion of the intake passage 4 on the upstream side of the throttle valve 3 and on the downstream side of an air cleaner 6, as well as a pressure sensor 8 disposed in the intake manifold. The sensors for acquiring the intake air amount in the intake passage 4 are not limited to the intake air amount sensor 7 and the pressure sensor 8, and their positions and numbers are also not limited to those described above.

The failure type estimation unit 31 estimates a first failure in which the flow rate of recirculated exhaust gas is larger than the normal flow rate, when the difference between the intake air amount (this information is acquired by the intake air amount sensor 7) on the upstream side of the portion of the intake passage 4 connected to the exhaust gas recirculation passage 21 and the intake air amount (this information is acquired by the pressure sensor 8) on the downstream side of the portion of the intake passage 4 connected to the exhaust gas recirculation passage 21, with the exhaust gas recirculation valve 22 closed, is equal to or greater than a preset first threshold. In addition, the failure type estimation unit 31 estimates a second failure in which the flow rate of recirculated exhaust gas is smaller than the normal flow rate, when the difference between the intake air amounts on the upstream and downstream sides of the portion of the intake passage 4 connected to the exhaust gas recirculation passage 21, with the exhaust gas recirculation valve 22 open, is less than a preset third threshold.

That is, in both a state where a command for recirculated exhaust gas introduction control is issued (i.e., when the exhaust gas recirculation valve 22 is commanded open), and a state where the command is not issued (i.e., when the exhaust gas recirculation valve 22 is commanded fully closed), the failure type estimation unit 31 acquires information on the difference in the intake air amount before and after the recirculated exhaust gas flows into the intake air within the intake passage 4, and estimates the type of failure that has occurred in the exhaust gas recirculation device 20. If the difference is large (i.e., equal to or greater than the first threshold), the unit 31 estimates the first failure, whereas if the difference is low (i.e., less than the third threshold), the unit 31 estimates the second failure.

When estimating that the first failure has occurred in the exhaust gas recirculation device 20, the unit 31 is capable of estimating the first failure more accurately if the following conditions are met: (i) the difference between the intake air amounts on the upstream and downstream sides of the portion of the intake passage 4 connected to the exhaust gas recirculation passage 21is equal to or greater than the first threshold, and (ii) a condition in which a rotational fluctuation of the engine 1 is equal to or greater than a preset second threshold is detected a predetermined number of times.

Specifically, when the failure type estimation unit 31 estimates that the first failure has occurred in the exhaust gas recirculation device 20, failure diagnosis is first performed under a diagnosis start condition in which the air-fuel ratio is stable near the stoichiometric ratio (i.e., the ideal air-fuel ratio), during stoichiometric feedback control under idling conditions after engine warm-up has been completed (i.e., during hot idling). In the failure diagnosis, it is estimated that the first failure has occurred in the exhaust gas recirculation device 20 if the following requirements (a) “Ec (volumetric efficiency) deviation determination” and (b) “misfire determination” are simultaneously satisfied while a command to fully close the exhaust gas recirculation valve 22 is continuously issued for a predetermined period (e.g., 5 seconds):
(a) Ec deviation amount =MAPS-calculated Ec−AFS·calculated Ec>First threshold; and
(b) Combustion fluctuation index ΔNe<Second threshold.

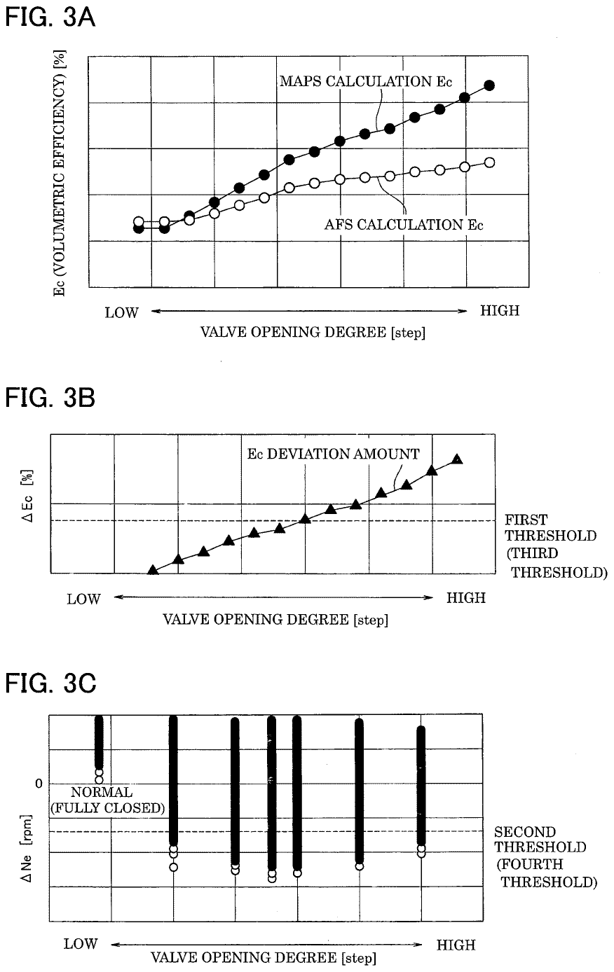

In the Ec deviation determination, the difference between the intake air amounts on the upstream and downstream sides of the portion of the intake passage 4 connected to the exhaust gas recirculation passage 21 is evaluated. The MAPS-calculated Ec represents a volumetric efficiency calculated based on information from the pressure sensor 8. The AFS-calculated Ec represents a volumetric efficiency calculated based on information from the intake air amount sensor 7 (see FIG. 3A). The Ec deviation amount is defined as the difference between the MAPS-calculated Ec and the AFS-calculated Ec (see FIG. 3B). As shown in FIGS. 3A and 3B, the Ec deviation amount increases as the opening degree of the exhaust gas recirculation valve 22 increases and the amount of recirculated exhaust gas increases. That is, if the Ec deviation amount exceeds the first threshold, it can be estimated that the exhaust gas recirculation valve 22 remains significantly open despite a command to fully close the exhaust gas recirculation valve 22. The combustion fluctuation index ΔNe represents a variation in rotational speed of the engine 1, and corresponds to the rotational fluctuation of the engine 1 (see FIG. 3C). If the combustion condition of the engine 1 deteriorates, the rotational speed of the engine 1 significantly decreases (i.e., the rotational fluctuation increases), and the combustion fluctuation index ΔNe falls below the second threshold. In this embodiment, as shown in FIG. 3C, the number of occurrences in which the combustion fluctuation index ΔNe falls below the second threshold is also counted. If the number of occurrences in which the combustion fluctuation index ΔNe falls below the second threshold exceeds a predetermined number, it is determined that the requirement (b), “misfire determination”, is satisfied. As the opening degree of the exhaust gas recirculation valve 22 increases and the amount of recirculated exhaust gas increases, the combustion condition of the engine 1 deteriorates, resulting in a significant decrease in the rotational speed of the engine 1. That is, if the combustion fluctuation index ΔNe falls below the second threshold (i.e., the rotational speed of the engine 1 is significantly reduced), it can be estimated that the exhaust gas recirculation valve 22 remains significantly open despite a command to fully close the exhaust gas recirculation valve 22. As the calculation method of the combustion fluctuation index ΔNe, various methods can be used. For example, the rotational fluctuation may be calculated from the output of a rotational speed sensor that acquires the rotational speed of the engine 1.

In addition, when estimating that the second failure has occurred in the exhaust gas recirculation device 20, more accurate estimation is possible if the following conditions are met: (i) the difference between the intake air amounts on the upstream and downstream sides of the portion of the intake passage 4 connected to the exhaust gas recirculation passage 21 is less than the third threshold, and (ii) a condition in which the rotational fluctuation of the engine 1 is equal to or greater than a preset fourth threshold is detected a predetermined number of times. The third threshold may be the same value as the first threshold. In addition, the fourth threshold may be the same value as the second threshold.

Specifically, when the failure type estimation unit 31 estimates that the second failure has occurred in the exhaust gas recirculation device 20, failure diagnosis is similarly performed under a diagnosis start condition in which the air-fuel ratio is stable near the stoichiometric ratio, during stoichiometric feedback control under hot idling conditions. In the failure diagnosis, it is estimated that the second failure has occurred in the exhaust gas recirculation device 20 if the following requirements (c) “Ec (volumetric efficiency) deviation determination” and (d) “misfire determination” are not satisfied while a command to open the exhaust gas recirculation valve 22 is continuously issued for a predetermined period (e.g., 5 seconds):
(c) Ec deviation amount=MAPS·calculated Ec−AFS·calculated Ec>Third threshold; and
(d) Combustion fluctuation index ΔNe<Fourth threshold.

That is, if neither the requirement (c) nor (d) is satisfied, although a predetermined amount of recirculated exhaust gas is supposed to be introduced, neither Ec deviation nor rotational fluctuation occurs. As a result, the second failure is estimated, indicating insufficient introduction of recirculated exhaust gas.

The failure estimation method performed by the failure type estimation unit 31 is not limited to the above example. For example, although the diagnostic accuracy is slightly reduced, the failure of the exhaust gas recirculation device 20 may be estimated as either the first failure or the second failure based solely on fluctuation information of the intake air amount obtained from the pressure sensor 8 (i.e., intake manifold pressure).

Based on the failure estimation result obtained by the above-mentioned failure type estimation unit 31, the determination unit 32 performs failure diagnosis by changing the opening degree of the exhaust gas recirculation valve 22 according to the estimated type of failure. By changing the opening degree of the exhaust gas recirculation valve 22 during failure diagnosis, the accuracy of failure determination can be improved.

The determination unit 32 performs the following determination based on the difference ΔP=P′−P between the intake manifold pressure (P) when a command to fully close the exhaust gas recirculation valve 22 is issued, i.e., the output value from the pressure sensor 8, and the intake manifold pressure (P′) when a command to open the exhaust gas recirculation valve 22 is issued: (i) when the difference ΔP=P′−P is equal to or greater than a predetermined value, it is determined that the exhaust gas recirculation device 20 is in a normal condition, and (ii) when the difference ΔP=P′−P is less than the predetermined value, it is determined that a failure has occurred.

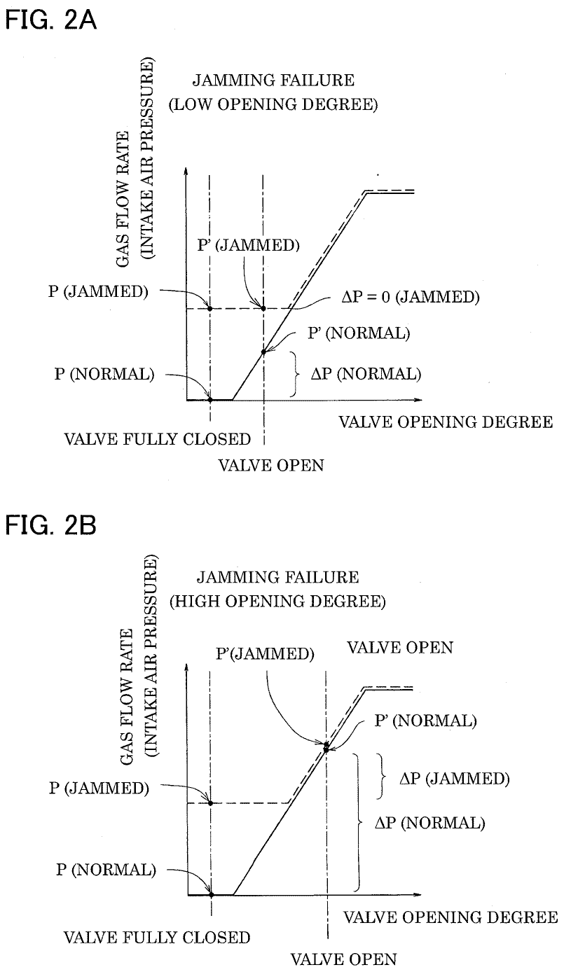

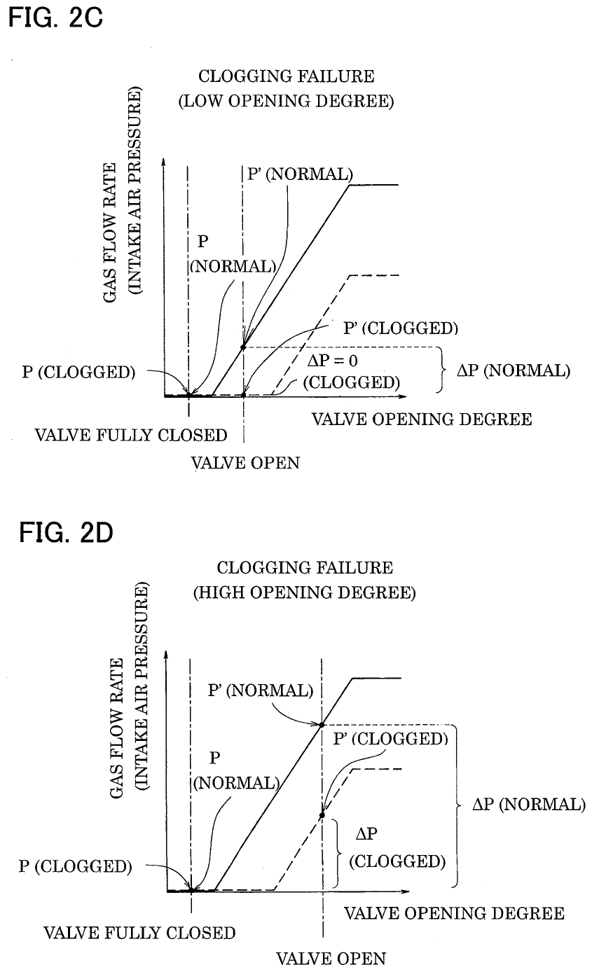

Specifically, if the first failure is estimated, the determination unit 32 sets the opening degree of the exhaust gas recirculation valve 22 set during failure diagnosis, i.e., the opening degree of the exhaust gas recirculation valve 22 during the acquisition of intake manifold pressure (P′) so as to be lower than the opening degree of the exhaust gas recirculation valve 22 when the first failure is not estimated. The opening degree of the exhaust gas recirculation valve 22 during the acquisition of intake manifold pressure (P′) (i.e., the basic opening degree) is determined based on a map that includes the relationship between the engine rotational speed and the opening degree of the exhaust gas recirculation valve 22. In the case of the first failure, a correction is applied to decrease the basic opening degree, whereby the opening degree of the exhaust gas recirculation valve 22 is corrected downward relative to the engine rotational speed on the map. FIG. 2A shows an example of the first failure in which the basic opening degree is decreased due to jamming caused by foreign matter in the exhaust gas recirculation valve 22 (i.e., a failure in which the valve cannot be fully closed) (i.e., an example in which the basic opening degree is lower than the jammed opening degree), and FIG. 2B shows an example of the first failure in which the basic opening degree is increased due to jamming caused by foreign matter in the exhaust gas recirculation valve 22 (i.e., an example in which the basic opening degree is greater than the jammed opening degree).

In FIG. 2A, when jamming caused by foreign matter occurs (represented by the broken line), the difference ΔP=P′−P between the intake manifold pressure (P) when the valve is fully closed and the intake manifold pressure (P′) when the valve is open becomes extremely small (i.e., substantially zero), so that it can be determined that a failure has occurred. In contrast, in FIG. 2B, even when jamming caused by foreign matter occurs (represented by the broken line), the aforementioned difference ΔP=P′−P becomes equal to or greater than the predetermined value, so that it cannot be determined that a failure has occurred. Thus, when jamming caused by foreign matter occurs, the lower the basic opening degree is, the more easily it can be determined that a failure has occurred. When the exhaust gas recirculation valve 22 is stuck in an open state, even if the basic opening degree is set to any value, the difference ΔP=P′−P between the intake manifold pressure P when a command to fully close the exhaust gas recirculation valve 22 is issued and the intake manifold pressure P′ when a command to open the exhaust gas recirculation valve 22 is issued becomes extremely small (i.e., substantially zero), thereby enabling highly accurate failure determination regardless of the basic opening degree.

In addition, if the second failure is estimated, the determination unit 32 sets the opening degree of the exhaust gas recirculation valve 22 set during failure diagnosis so as to be greater than the opening degree of the exhaust gas recirculation valve 22 when the second failure is not estimated. That is, in the case of the second failure, a correction is applied to increase the basic opening degree, whereby the opening degree of the exhaust gas recirculation valve 22 is corrected upward relative to the engine rotational speed on the map. FIG. 2C shows an example of the second failure in which the basic opening degree is decreased due to clogging caused by foreign matter in the exhaust gas recirculation passage 21 (i.e., a failure in which foreign matter hinders the flow of the recirculated exhaust gas), meaning the recirculated exhaust gas does not flow even at the basic opening degree, and FIG. 2D shows an example of the second failure in which the opening degree is increased due to clogging caused by foreign matter in the exhaust gas recirculation passage 21 (i.e., an example in which the recirculated exhaust gas flows at the basic opening degree). In FIG. 2C, when clogging caused by foreign matter occurs (represented by the broken line), the aforementioned difference ΔP=P′−P becomes extremely small (i.e., substantially zero), and therefore it is determined that a failure has occurred. In contrast, in FIG. 2D, even when clogging caused by foreign matter occurs (represented by the broken line), the difference ΔP=P′−P becomes a value equal to or greater than a predetermined value, and therefore it is not determined that a failure has occurred.

As a result, diagnosis is performed based on the degree of urgency. That is, regardless of whether either the first failure or the second failure is estimated, the lower the basic opening degree is, the more easily it can be determined that a failure has occurred. However, since the second failure, in which the flow rate of the recirculated exhaust gas decreases, does not itself cause deterioration of the exhaust gas, the degree of urgency of the failure is considered low. Therefore, the criteria for failure determination are intentionally tightened by applying a correction that increases the basic opening degree.

In contrast, due to the first failure, the flow rate of the recirculated exhaust gas is larger than the normal flow rate, which may result in unstable combustion and deterioration of the exhaust gas. Therefore, when the first failure is estimated, a correction is applied to decrease the basic opening degree, thereby facilitating the determination that a failure has occurred.

In addition, the determination unit 32 notifies an occupant of occurrence of a failure only when it is determined that the first failure has occurred, and does not notify the occupant when it is determined that the second failure has occurred. As a result, unnecessary notifications to the occupant are reduced.

The failure diagnosis is performed during a fuel cut operation of the engine 1 (i.e., during vehicle deceleration). According to the above-described method, the opening degree of the exhaust gas recirculation valve 22 is decreased during the failure diagnosis. As a result, the rotational resistance of the engine 1 increases, and a deceleration feel of the vehicle during the fuel cut operation can be ensured.

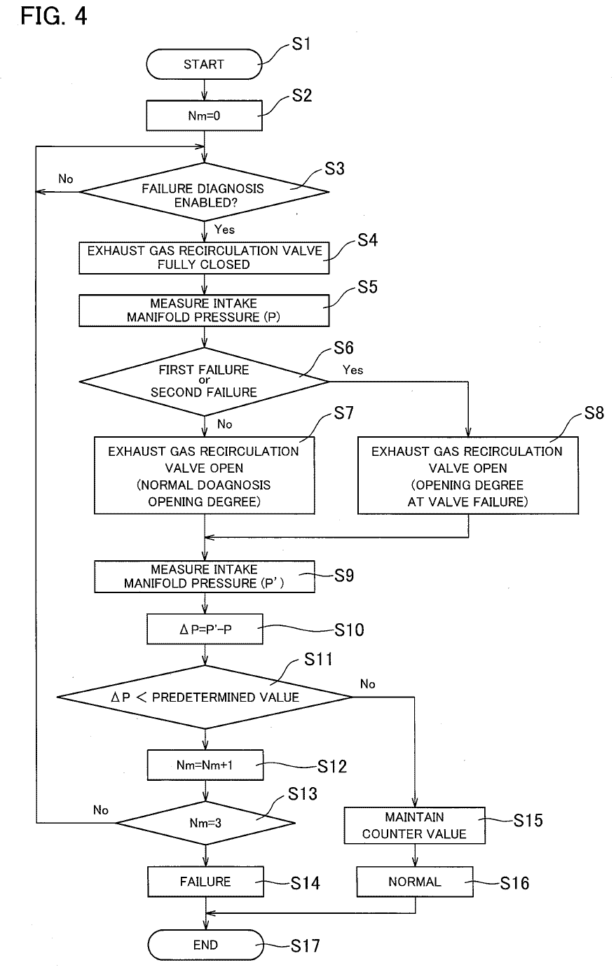

FIG. 4 is a flowchart illustrating the control process. The control process is started in Step S1. In Step S2, the counter value is reset (i.e., Nm=0). In Step S3, it is determined whether failure diagnosis is enabled. The requirements for enabling the failure diagnosis are (i) that the engine 1 is in a fuel cut operation and (ii) that both the volumetric efficiency and rotational speed of the engine 1 are within predetermined ranges. If failure diagnosis is enabled, the process proceeds to Step S4, and if failure diagnosis is not enabled, Step S3 is repeated.

Under a command to fully close the exhaust gas recirculation valve 22 in Step S4, the process proceeds to Step S5, in which the intake manifold pressure (P) is measured. The intake manifold pressure (P) is acquired by the pressure sensor 8 while the command to fully close the exhaust gas recirculation valve 22 is being issued. Then, in Step S6, it is determined whether either the first failure or the second failure has been already estimated and whether either the first failure or the second failure has occurred.

If either the first failure or the second failure has been already estimated when proceeding to Step S6, the process proceeds to Step S8, in which a correction of the opening degree of the exhaust gas recirculation valve 22 is performed during failure diagnosis (i.e., the opening degree at the failure of the exhaust gas recirculation valve). As described above, in the case of the first failure, the opening degree correction is a correction to decrease the opening degree, whereas in the case of the second failure, the opening degree is a correction to increase the opening degree. If the failure type estimation unit 31 estimates both the first failure and the second failure, the determination unit 32 decreases the opening degree of the exhaust gas recirculation valve 22 set during failure determination. That is, if there is a concern about both the first failure and the second failure, priority is given to facilitating the determination of the first failure, in consideration of safety. If it is estimated that neither the first failure nor the second failure has occurred when proceeding to Step S6, the process proceeds to Step S7, in which failure diagnosis is performed at the normal opening degree (i.e., the normal diagnosis opening degree). Even if neither the first failure nor the second failure is estimated, the process proceeds to Step S7, and failure diagnosis is performed at the normal opening degree.

Next, the process proceeds to Step S9, in which the intake manifold pressure (P′) is measured. In Step S10, the difference between the intake manifold pressure (P) and the intake manifold pressure (P′) is calculated, i.e., ΔP=P′−P.

If the difference ΔP=P′−P is equal to or greater than a predetermined value in Step S11, the process proceeds to Step S15, in which the counter value is maintained. In the subsequent Step S16, it is determined that the exhaust gas recirculation device 20 is in a normal condition, and the control process ends in Step S17. In contrast, if the difference ΔP=P′−P is less than the predetermined value in Step S11, the process proceeds to Step S12, in which the counter value is incremented by one (i.e., Nm=Nm+1). The steps from Step 3 to Step 12 are then repeated. If it is determined in Step S13 that the counter value has reached 3 (i.e., Nm=3), indicating that failure determination has been performed three times, in the subsequent Step S14, it is determined that a failure (i.e., either the first failure or the second failure) has occurred, and the control process ends in Step S17. The counter value for determining that a failure has occurred is not limited to 3, and may be set to an appropriate value.

While, in the above embodiment, the arrangement of the present invention is described using, as an example, an engine 1 that is not equipped with a forced induction device, the present invention may be applied to an engine 1 equipped with a forced induction device. In addition, the engine 1 may be equipped with the exhaust gas recirculation device 20 in the form of either a high-pressure exhaust gas recirculation device or a low-pressure exhaust gas recirculation device, or both. The high-pressure exhaust gas recirculation device includes an exhaust gas recirculation passage 21 that connects the downstream side of a compressor and the upstream side of a turbine of a turbocharger and handles relatively high-pressure exhaust gas. The low pressure exhaust gas recirculation device includes an exhaust gas recirculation passage 21 that connects the upstream side of the compressor and the downstream side of the turbine of the turbocharger and handles relatively low pressure exhaust gas. Furthermore, the engine 1 to which the present invention is applicable may be, for example, a gasoline engine or a diesel engine, but is not limited thereto.

### DESCRIPTION OF REFERENCE NUMERALS

1: Engine
2: Combustion chamber (Cylinder)
3: Throttle valve
4: Intake passage
5: Exhaust passage
6: Air cleaner
7: Intake air pressure sensor
8: Pressure sensor
10: Injection device (In-cylinder injection device)
13: Exhaust gas cleaner
20: Exhaust gas recirculation device
21: Exhaust gas recirculation passage
22: Exhaust gas recirculation valve
30: Electronic control unit
31: Failure type estimation unit
32: Determination unit

1. A failure detection device for an exhaust gas recirculation device, the exhaust gas recirculation device comprising:
an exhaust gas recirculation passage through which an exhaust passage and an intake passage of an engine communicate with each other, and
an exhaust gas recirculation valve disposed in the exhaust gas recirculation passage, wherein the failure detection device comprises:
a failure type estimation unit for estimating a type of failure that has occurred in the exhaust gas recirculation device; and
a determination unit for determining presence or absence of a failure from an intake air pressure change when opening degree of the exhaust gas recirculation valve is changed during a fuel cut operation, and
wherein the determination unit is configured to determine the presence or absence of a failure by changing the opening degree of the exhaust gas recirculation valve in accordance with the type of failure estimated by the failure type estimation unit during failure diagnosis.

2. The failure detection device according to claim 1, wherein the failure type estimation unit is configured to estimate a first failure in which a flow rate of recirculated exhaust gas is larger than a normal flow rate, when a difference between an intake air amount on an upstream side of a connection portion of the intake passage connected to the exhaust gas recirculation passage and an intake air amount on a downstream side of the connection portion of the intake passage, with the exhaust gas recirculation valve closed, is equal to or greater than a first threshold, and
wherein the determination unit is configured to set, when the first failure is estimated, the opening degree of the exhaust gas recirculation valve so as to be lower than the opening degree of the exhaust gas recirculation valve when the first failure is not estimated.

3. The failure detection device according to claim 2, wherein the failure type estimation unit is configured to estimate the first failure when (i) the difference between the intake air amounts on the upstream side and the downstream side of the connection portion of the intake passage is equal to or greater than the first threshold, and (ii) a condition in which a rotational fluctuation of the engine is equal to or greater than a second threshold is detected a predetermined number of times.

4. The failure detection device according to claim 2, wherein the failure type estimation unit is configured to estimate a second failure in which the flow rate of recirculated exhaust gas is smaller than a normal flow rate, when the difference between the intake air amounts on the upstream side and the downstream side of the connection portion of the intake passage, with the exhaust gas recirculation valve open, is less than a third threshold, and
wherein the determination unit is configured to set, when the second failure is estimated, the opening degree of the exhaust gas recirculation valve during failure diagnosis so as to be greater than the opening degree of the exhaust gas recirculation valve when a failure other than the second failure is estimated.

5. The failure detection device according to claim 4, wherein the failure type estimation unit is configured to estimate the second failure when (i) the difference between the intake air amounts on the upstream side and the downstream side of the connection portion of the intake passage is less than the third threshold, and (ii) a condition in which a rotational fluctuation of the engine is equal to or greater than a fourth threshold is detected a predetermined number of times.

6. The failure detection device according to claim 4, wherein, when the failure type estimation unit estimates both the first failure and the second failure, the determination unit is configured to decrease the opening degree of the exhaust gas recirculation valve set during failure diagnosis.

7. The failure detection device according to claim 4, wherein the determination unit is configured to notify an occupant of occurrence of a failure only when it is determined that the first failure has occurred.

8. The failure detection device according to claim 3, wherein the failure type estimation unit is configured to estimate a second failure in which the flow rate of recirculated exhaust gas is smaller than a normal flow rate, when the difference between the intake air amounts on the upstream side and the downstream side of the connection portion of the intake passage, with the exhaust gas recirculation valve open, is less than a third threshold, and
wherein the determination unit is configured to set, when the second failure is estimated, the opening degree of the exhaust gas recirculation valve during failure diagnosis so as to be greater than the opening degree of the exhaust gas recirculation valve when a failure other than the second failure is estimated.

9. The failure detection device according to claim 8, wherein the failure type estimation unit is configured to estimate the second failure when (i) the difference between the intake air amounts on the upstream side and the downstream side of the connection portion of the intake passage is less than the third threshold, and (ii) a condition in which the rotational fluctuation of the engine is equal to or greater than a fourth threshold is detected a predetermined number of times.

10. The failure detection device according to claim 5, wherein, when the failure type estimation unit estimates both the first failure and the second failure, the determination unit is configured to decrease the opening degree of the exhaust gas recirculation valve set during failure diagnosis.

11. The failure detection device according to claim 8, wherein, when the failure type estimation unit estimates both the first failure and the second failure, the determination unit is configured to decrease the opening degree of the exhaust gas recirculation valve set during failure diagnosis.

12. The failure detection device according to claim 9, wherein, when the failure type estimation unit estimates both the first failure and the second failure, the determination unit is configured to decrease the opening degree of the exhaust gas recirculation valve set during failure diagnosis.

13. The failure detection device according to claim 5, wherein the determination unit is configured to notify an occupant of occurrence of a failure only when it is determined that the first failure has occurred.

14. The failure detection device according to claim 6, wherein the determination unit is configured to notify an occupant of occurrence of a failure only when it is determined that the first failure has occurred.

15. The failure detection device according to claim 8, wherein the determination unit is configured to notify an occupant of occurrence of a failure only when it is determined that the first failure has occurred.

16. The failure detection device according to claim 9, wherein the determination unit is configured to notify an occupant of occurrence of a failure only when it is determined that the first failure has occurred.

17. The failure detection device according to claim 10, wherein the determination unit is configured to notify an occupant of occurrence of a failure only when it is determined that the first failure has occurred.

18. The failure detection device according to claim 11, wherein the determination unit is configured to notify an occupant of occurrence of a failure only when it is determined that the first failure has occurred.

19. The failure detection device according to claim 12, wherein the determination unit is configured to notify an occupant of occurrence of a failure only when it is determined that the first failure has occurred.
